(19) United States
(12) Patent Application Publication
(10) Pub. No.: US 2014/0331584 A1
(43) Pub. Date: Nov. 13, 2014

(54) DIVIDING WALL PANEL AND METHOD OF MANUFACTURING SAME

(71) Applicant: Victor AMEND, Toronto (CA)

(72) Inventor: Victor AMEND, Toronto (CA)

(21) Appl. No.: 13/893,028

(22) Filed: May 13, 2013

(51) Int. Cl. E04B 1/94; B29D 99/00

(52) U.S. Cl. CPC E04B 1/942; B29D 99/0021
USPC 52/309.12; 52/741.3; 52/745.09; 264/46.5

(57) ABSTRACT

A dividing wall panel comprises at least one elongate, fire-resistant hardboard sheet, and an elongate insulating foam slab joined to the at least one hardboard sheet. The insulating foam slab is formed from a molded, continuous foam body compressed either during molding or after molding, or both, to improve its sound insulation properties.

### PRIORITY

This application claims the benefit of U.S. Design Patent application Ser. No. 29/433,038 entitled “INSULATING WALL PANEL” and filed on Sep. 25, 2012, and U.S. Design Patent application Ser. No. 29/440,129 entitled “INSULATING WALL PANEL” and filed on Dec. 19, 2012, the contents of which are incorporated herein by reference in their entireties.

### BACKGROUND

1. Field of the Invention

The present invention relates generally to building structures and in particular, to a dividing wall panel and a method of manufacturing same.

2. Background of the Invention

In the field of building and construction, dividing walls, sometimes referred to as “party walls”, are used for separating adjacent units of a multiple unit building structure, such as for example adjacent dwelling units of an apartment building. Dividing walls typically need to provide a minimum level of fire resistance, so as to comply with the fire resistance requirements of local building codes, for example. It is desired that dividing walls also provide some amount of sound insulation, so as to reduce the conduction of sound therethrough for privacy.

Conventional dividing walls are often constructed by forming two (2) walls of cinder blocks against, and on either side of, a row of metal posts, such as for example a row of vertically-oriented “C”-shaped channels. However, as the cinder blocks are in contact with the metal posts, sound is readily conducted through such conventional dividing walls.

Other conventional dividing walls may comprise drywall sheets fastened to the outside of two (2) rows of metal posts, such as for example two (2) rows of vertically-oriented “Z”-shaped channels. A space separating the two (2) rows of metal posts is typically filled with mineral glass wool, so as to improve the fire resistance rating of the dividing wall. However, as the mineral glass wool is in contact with the drywall sheets and the metal posts, sound is readily conducted through such conventional dividing walls.

More recently, prefabricated building panels have become a commonly-used material in the construction of residential homes and other building structures due to their low cost, high strength, high energy efficiency, and ease of installation. Such panels are typically fabricated as sheets of a standard size (e.g. 4 feet×8 feet), which can then be cut to size on-site as needed prior to installation.

Prefabricated building panels for use in dividing walls have been considered. For example, U.S. Patent Application Publication No. 2004/0068948 to Wrass discloses a party wall panel having a foam core, at least one structural stud partially embedded in a first face of the core and at least one structural stud partially embedded in a second face of the core, and a concrete member covering the second face of the core. A fire-resistant sheet is affixed to the structural stud in the first face of the core. The fire-resistant sheet is spaced from the first face and defines a first sound channel therebetween. A spacer is affixed to the structural stud in the second face of the core and exterior of the concrete member. A fire-resistant sheet is affixed to the spacer, and the fire-resistant sheet is thereby spaced from the concrete member and defines a sound channel therebetween.

U.S. Pat. No. 7,032,356 to Layfield discloses an interior wall construction comprising a compressed straw panel situated in a substantially layered configuration with conventional non-woven insulation, at least one air space, and a gypsum board sheet on each face. A connection between the compressed straw panel and at least one gypsum board sheet comprises semi-flexible, substantially Z-shaped channel members. The Z-shaped channel members and compressed straw panel are each capable of partially attenuating sound energy passed therethrough.

Improvements are generally desired. It is therefore an object of the present invention at least to provide a novel dividing wall panel and method of manufacturing same.

### SUMMARY OF THE INVENTION

Accordingly, in one aspect there is provided a dividing wall panel comprising: at least one elongate, fire-resistant hardboard sheet; and an elongate insulating foam slab joined to the at least one hardboard sheet, the insulating foam slab being formed from a molded, continuous foam body compressed either during molding or after molding, or both, to improve its sound insulation properties.

Each hardboard sheet may have an outwardly-facing surface, and each hardboard sheet may further comprise a longitudinal groove extending along each longitudinal edge of the outwardly-facing surface.

The dividing wall panel may further comprise at least one longitudinal recess, each longitudinal recess being adjacent an inwardly-facing surface of each hardboard sheet. Each longitudinal recess may be sized to accommodate at least a portion of a vertically-oriented wall frame member. The vertically-oriented wall frame member may be a wall stud.

The dividing wall panel may further comprise at least one transverse recess, each transverse recess being adjacent an inwardly-facing surface of each hardboard sheet. Each transverse recess may be sized to accommodate at least a portion of a horizontally-oriented wall frame member. The wall frame member may be a header or a baseplate.

The insulating foam slab may be fabricated of molded expanded polystyrene foam.

Each hardboard sheet may be fabricated of magnesium oxide or comprise a fiber cement board.

The insulating foam slab may be joined to each hardboard sheet by a glue layer.

The continuous foam body may be subjected to at least one compression cycle.

In one embodiment, a dividing wall may incorporate the dividing wall panel.

In another embodiment, a method of fabricating a dividing wall may comprise fastening at least one dividing wall panel to each of a first row of wall frame members and a second row of wall frame members, the first row of wall frame members being spaced from the second row of wall frame members such that opposing dividing wall panels fastened to the wall frame members are separated by an air gap.

In another aspect, there is provided a method of fabricating a dividing wall panel, comprising joining at least one fire-resistant hardboard sheet to an insulating foam slab, the insulating foam slab having been formed by compressing a continuous foam body to form the insulating foam slab having improved sound insulation properties.

The method may further comprise at least partially filling a mold with particles; and applying heat to the particles within the mold to form the continuous foam body.

The method may further comprise forming the insulating foam slab by one or more of: applying external pressure to compress the continuous foam body within a mold used for molding the continuous foam body; and removing the continuous foam body from a mold used for molding the continuous foam body, and applying external pressure to compress the continuous foam body.

The compressing may comprise permanently increasing the density of the continuous foam body.

The joining may comprise disposing a glue layer between each hardboard sheet and the insulating foam slab.

The method may further comprise forming a longitudinal groove extending along a longitudinal edge of an outwardly-facing surface of each hardboard sheet.

The method may further comprise forming at least one longitudinal recess along a longitudinal side surface of the insulating foam slab by at least one of machining, hot wire cutting and molding.

The compressing may comprise subjecting the continuous foam body to at least one compression cycle.

The method may further comprise cutting the insulating foam slab from another insulating foam slab of larger size.

The method may further comprise cutting the continuous foam body from another continuous foam body of larger size either prior to, during or after the compressing.

### BRIEF DESCRIPTION OF THE DRAWINGS

Embodiments will now be described more fully with reference to the accompanying drawings in which:

FIG. 1 is a perspective view of a dividing wall panel;

FIG. 2 is a front elevational view of the dividing wall panel of FIG. 1;

FIG. 3 is a side view of the dividing wall panel of FIG. 1;

FIG. 4 is an end view of the dividing wall panel of FIG. 1;

FIG. 5 is a rear elevational view of the dividing wall panel of FIG. 1;

FIG. 6 is an opposite side view of the dividing wall panel of FIG. 1;

FIG. 7 is an opposite end view of the dividing wall panel of FIG. 1;

FIG. 8 is an enlarged fragmentary view of the dividing wall panel of FIG. 3 identified by reference numeral 8;

FIG. 9 is an enlarged fragmentary view of the dividing wall panel of FIG. 4 identified by reference numeral 9;

FIG. 10 is a top sectional view of a portion of a dividing wall incorporating the dividing wall panel of FIG. 1;

FIG. 11 is a perspective view of another embodiment of a dividing wall panel;

FIG. 12 is a front elevational view of the dividing wall panel of FIG. 11;

FIG. 13 is a side view of the dividing wall panel of FIG. 11;

FIG. 14 is an end view of the dividing wall panel of FIG. 11;

FIG. 15 is a top sectional view of still another embodiment of a dividing wall panel; and

FIG. 16 is a top sectional view of a portion of another embodiment of a dividing wall incorporating the dividing wall panel of FIG. 15.

### DETAILED DESCRIPTION OF THE EMBODIMENTS

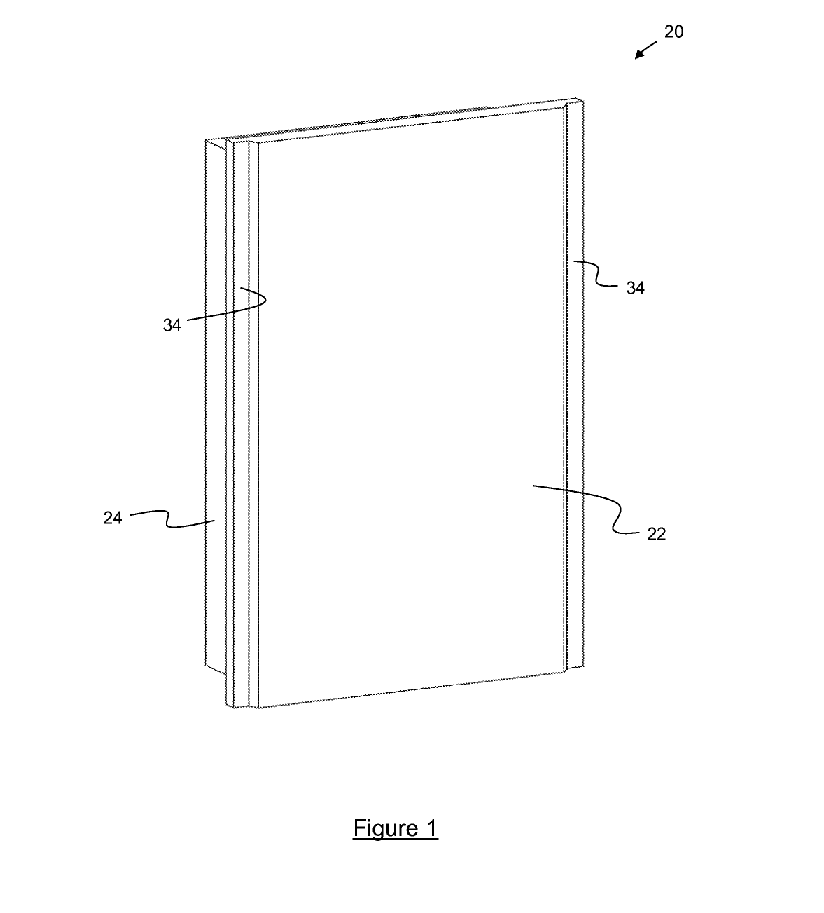

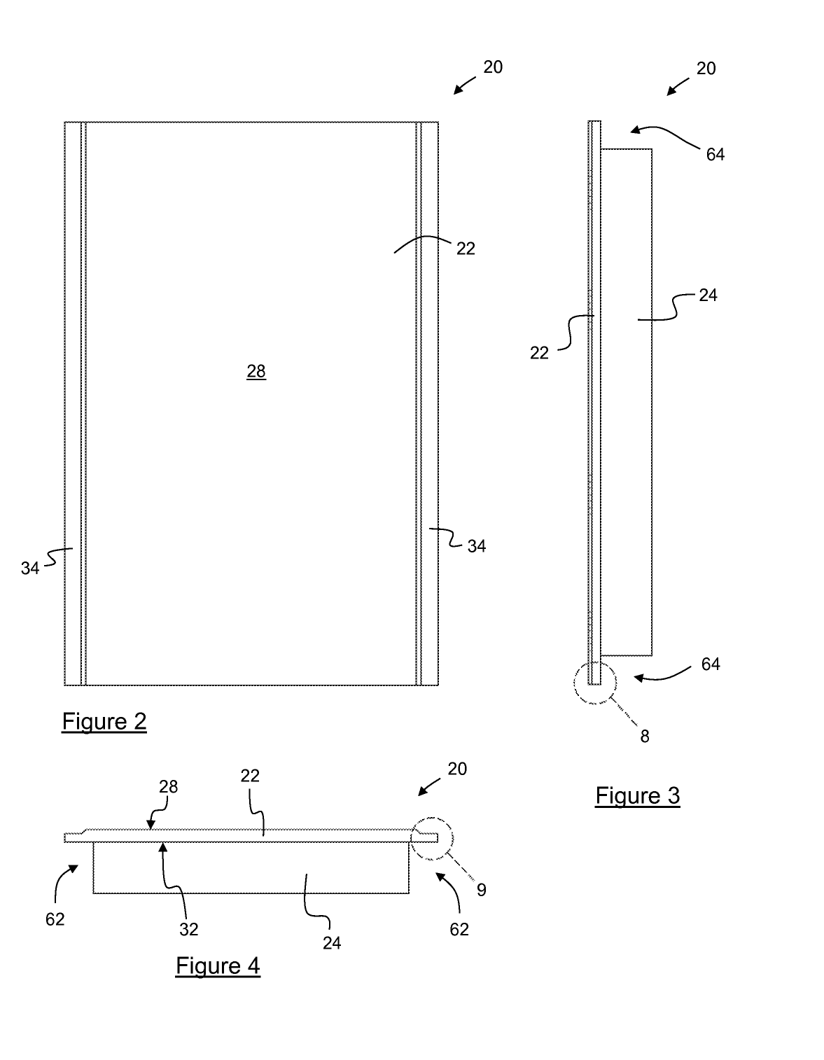

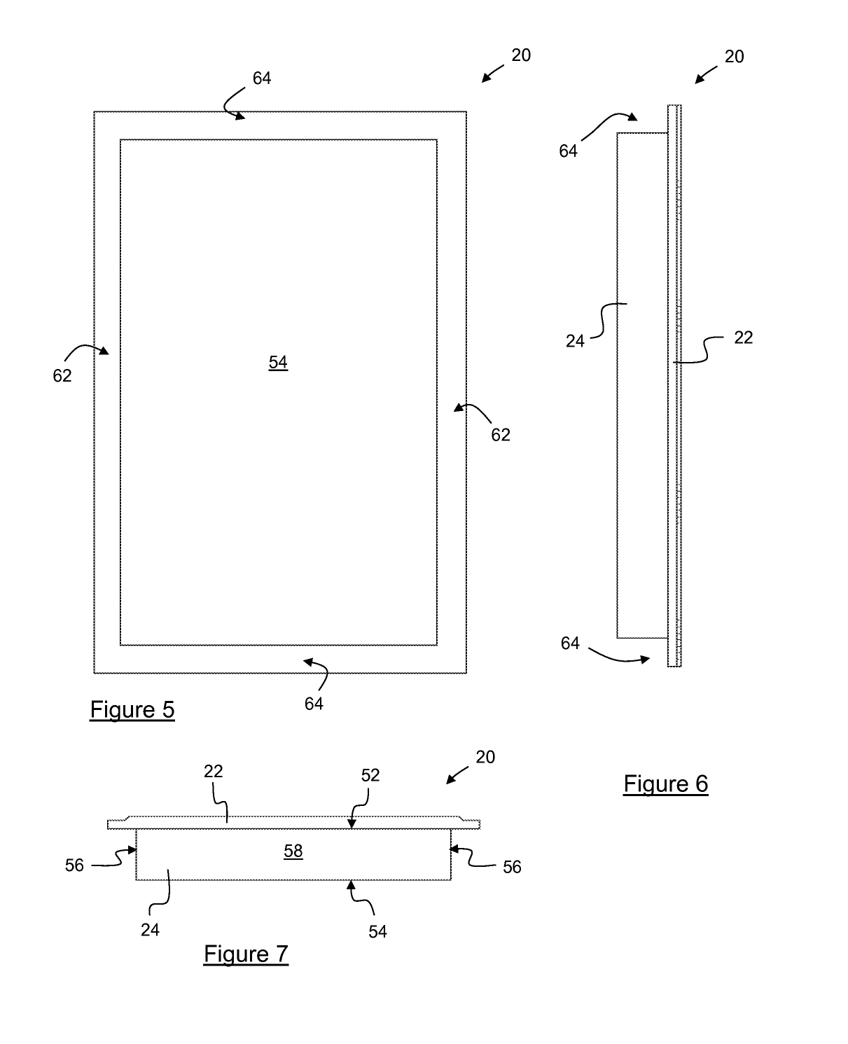

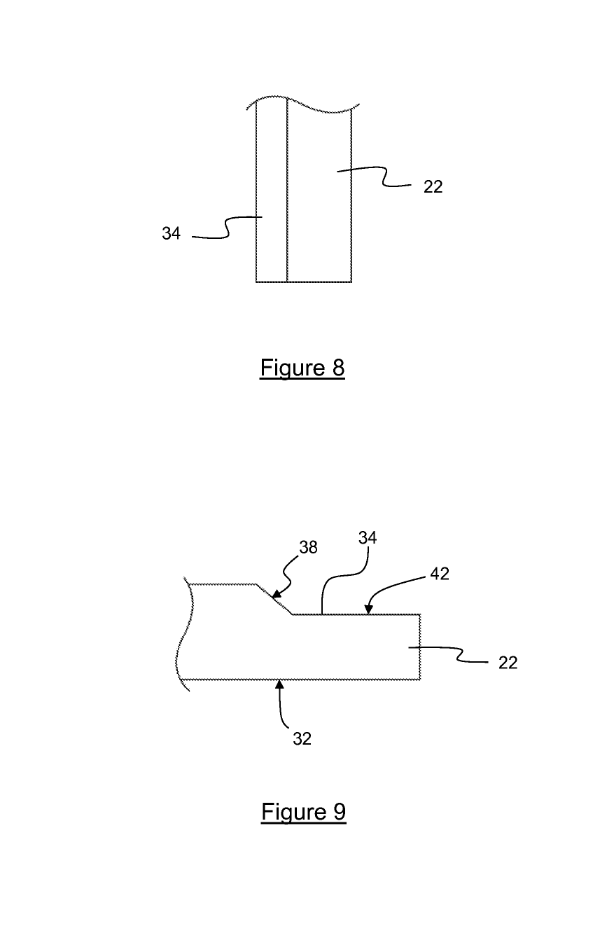

Turning now to FIGS. 1 to 9, a dividing wall panel is shown and is generally indicated by reference numeral 20. Panel 20 comprises a fire-resistant hardboard sheet 22 that is joined to an insulating foam slab 24. The insulating foam slab 24 is formed from a molded, continuous foam body that has been compressed either during or after molding, or both, to improve its sound insulation properties. The panel 20 is for use in a dividing wall situated between adjacent, separate units of a multiple unit building structure (not shown), such as for example between adjacent dwelling units of an apartment building.

The hardboard sheet 22 has a generally planar, elongate shape, and is fabricated of a fire-resistant material. In this embodiment the hardboard sheet 22 is fabricated of magnesium oxide. The hardboard sheet 22 has an outwardly-facing surface 28 and an inwardly-facing surface 32. The hardboard sheet 22 also has two (2) longitudinal grooves 34 formed therein, with each longitudinal groove 34 extending along a longitudinal edge of the outwardly-facing surface 28. Each longitudinal groove 34 has a beveled surface 38 and a recessed surface 42. As may be seen, the thickness of the hardboard sheet 22 between the inwardly-facing surface 32 and each recessed surface 42 is less than the thickness within the remainder of the hardboard sheet 22.

In this embodiment, the insulating foam slab 24 has a monolithic, elongate shape, and is fabricated of molded expanded polystyrene (EPS) foam. During fabrication of the insulating foam slab 24, a mold (not shown) of a molding machine (not shown) is filled at least partially with EPS particles, sometimes referred to in the art as EPS “beads”. The molding machine is configured to apply heat to the mold, such as for example by passing hot air or steam through the mold. In this embodiment, the mold has at least one moveable wall (not shown) that is configured to move along the thickness direction of the mold, and the molding machine is further configured to apply external pressure to the mold for moving the at least one moveable wall inwardly and outwardly in response to the application and relaxation of external pressure, respectively.

After filling with the EPS particles, the molding machine applies heat to the mold so as to heat the EPS particles to above their melting point. The applied heat causes the EPS particles therein to form a continuous foam body (not shown) that comprises a cell structure (not shown), as is known in the art. After the continuous foam body has been formed, the molding machine applies external pressure to the mold. As will be understood, inward movement of the at least one moveable wall causes the continuous foam body within the mold to be compressed along the thickness direction. By this approach, the continuous foam body is compressed “during” molding. In this embodiment, the molding machine applies a plurality of cycles of external pressure and relaxation to the mold, such that the continuous foam body within the mold undergoes a plurality of compression cycles.

As a result of the compression, the cell structure within the continuous foam body is deformed and the density of the continuous foam body is permanently increased, resulting in the insulating foam slab 24. Deformation of the cell structure of the continuous foam body improves the sound insulation properties of the foam, as described for example in U.S. Pat. No. 5,520,873 to Liene. As will be understood, such an improvement in the sound insulation properties of the foam enables the insulating foam slab 24 to provide greater attenuation of sound energy, and therefore to provide better sound insulation, as compared to the uncompressed continuous foam body.

The insulating foam slab 24 is sized such that its length is less than the length of the hardboard sheet 22, and such that its width is less than the width of the hardboard sheet 22. The insulating foam slab 24 has an inner surface 52, an outer surface 54, two (2) longitudinal side surfaces 56 and two (2) transverse side surfaces 58. In this embodiment, the length, width and thickness of the insulating foam slab 24 generally correspond to the internal dimensions of the mold cavity (not shown) of the mold.

The insulating foam slab 24 is joined to the hardboard sheet 22 by a glue layer disposed between the inner surface 52 and the inwardly-facing surface 32. In this embodiment, the glue layer comprises hot melt adhesive.

As a result of the shorter length and shorter width of the insulating foam slab 24 relative to the hardboard sheet 22, the panel 20 comprises two (2) longitudinal recesses 62 and two (2) transverse recesses 64. Each longitudinal recess 62 is adjacent the inwardly-facing surface 32 of the hardboard sheet 22 and a longitudinal side surface 56 of the insulating foam slab 24, and is sized to accommodate at least a portion of a vertically-oriented wall frame member, such as for example a lumber wall stud. Each transverse recess 64 is adjacent the inwardly-facing surface 32 of the hardboard sheet 22 and a transverse side surface 58 of the insulating foam slab 24, and is sized to accommodate at least a portion of a horizontally-oriented wall frame member, such as for example a lumber header or baseplate.

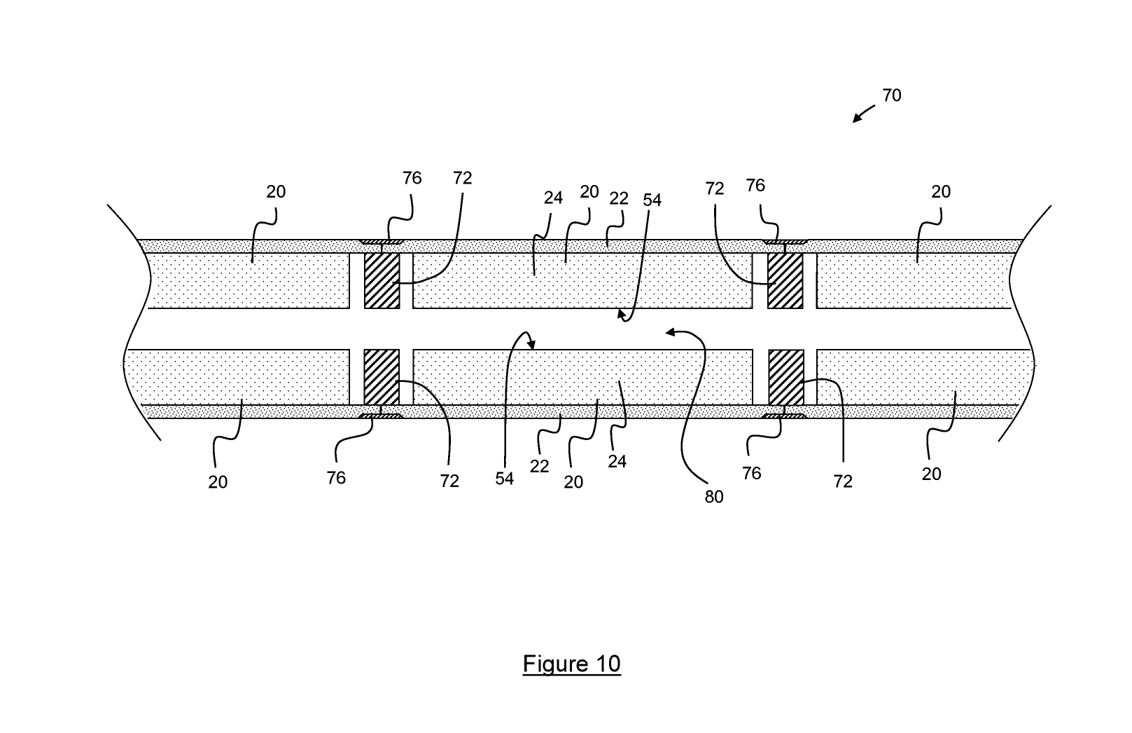

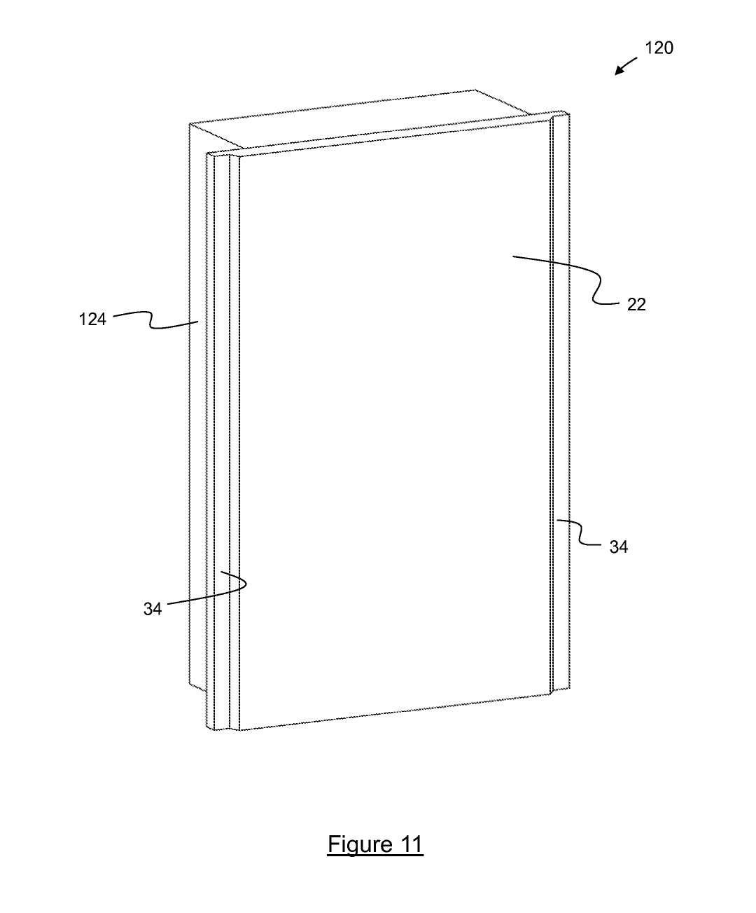

FIG. 10 shows a portion of a dividing wall incorporating the panel 20, and which is generally indicated by reference numeral 70. Dividing wall 70 is situated between adjacent, separate units of a multiple unit building structure (not shown), such as for example between adjacent dwelling units of an apartment building. The dividing wall 70 comprises a plurality of vertically-oriented wall frame members 72 arranged along two (2) rows, and in this embodiment the wall frame members 72 are lumber wall studs. The dividing wall 70 further comprises a plurality of panels 20 fastened to the wall frame members 72. As may be seen, the panels 20 are oriented in a “back-to-back” manner within the dividing wall 70, such that the outer surfaces 54 of the insulating foam slabs 24 of opposing panels 20 face each other.

Each panel 20 is fastened to at least one wall frame member 72 using fasteners (not shown), and in this embodiment the fasteners are screws. Each fastener extends from the recessed surface 42 of the hardboard sheet 22 into the wall frame member 72. The panels 20 are fastened to the wall frame members 72 such that the hardboard sheets 22 of two (2) adjacent panels 20 abut along their longitudinal edges. As will be understood, when fastened in this manner, the longitudinal grooves 34 of two (2) abutting, adjacent panels 20 combine to form a vertically-oriented longitudinal trough. Each longitudinal trough has a quantity 76 of filler material disposed therein. In this embodiment, the filler material is joint compound. The quantity 76 of filler material conceals the joint formed between the abutting hardboard sheets 22, and is shaped so as to have a surface that is generally flush with the outwardly-facing surfaces 28 of the hardboard sheets 22. As a result, and advantageously, each outer surface 78 of the dividing wall 70 is generally continuous and generally planar.

Although not shown, the dividing wall 70 also comprises a plurality of horizontally-oriented wall frame members (not shown) arranged along the top and bottom of each row of vertically-oriented wall frame members 72, and joining the vertically-oriented wall frame members 72 in the manner known in the art of wall framing. In this embodiment, the horizontally-oriented wall frame members are lumber headers and lumber baseplates, and each panel 20 is fastened to at least one lumber header and at least one lumber baseplate using fasteners, with each of the at least one lumber header and the at least one lumber baseplate being accommodated by a respective transverse recess 64 of the panel 20.

The two (2) rows of wall frame members 72 are spaced from each other such that when the panels 20 are fastened to the wall frame members 72, the outer surfaces 54 of the insulating foam slabs 24 of opposing panels 20 are separated by an air gap 80. As will be understood, the air gap 80 advantageously ensures that no object extends continuously between the outer surfaces 78 of the dividing wall 70, which could otherwise provide a channel for sound conduction through the dividing wall. As a result, in addition to the improved sound insulation properties of the insulating foam slabs 24 of the panels 20, the air gap 80 effectively provides a sound insulation barrier within the dividing wall 70.

Although in the embodiment shown, when the panels 20 are fastened to the wall frame members 72, the wall frame member 72 is separated from each adjacent insulating foam slab 24 by an air gap, in other embodiments, the wall frame member may alternatively contact or abut against one or more adjacent insulating foam slabs 24 when the panels 20 are fastened thereto.

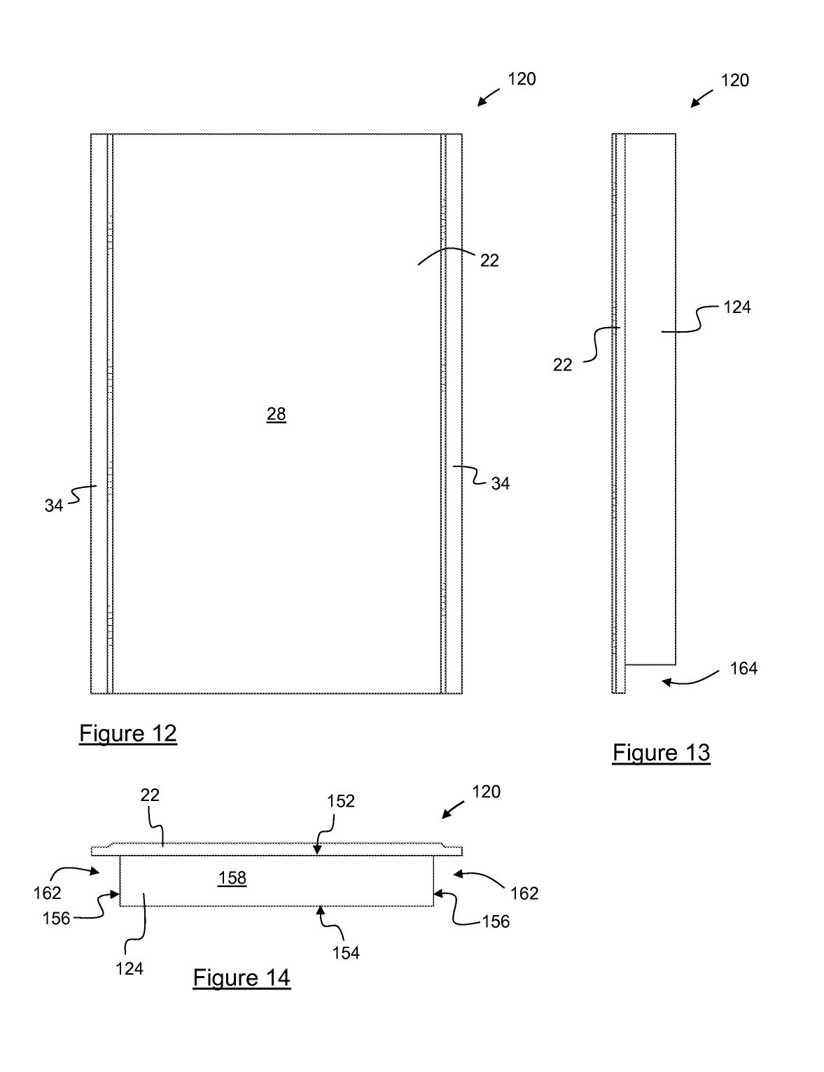

Other configurations are possible. For example, FIGS. 11 to 14 show another embodiment of a dividing wall panel, which is generally indicated by reference numeral 120. Panel 120 is generally similar to panel 20 described above and with reference to FIGS. 1 to 9, and comprises a fire-resistant hardboard sheet 22 that is joined to an insulating foam slab 124. The insulating foam slab 124 is formed from a molded, continuous foam body that has been compressed either during or after molding, or both, to improve its sound insulation properties.

The hardboard sheet 22 has been described above and with reference to FIGS. 1 to 9.

The insulating foam slab 124 has a monolithic, elongate shape, and is fabricated of molded expanded polystyrene (EPS) foam in the same manner as described above for insulating foam slab 24.

The insulating foam slab 124 is sized such that its length is less than the length of the hardboard sheet 22, and such that its width is less than the width of the hardboard sheet 22. The insulating foam slab 124 has an inner surface 152, an outer surface 154, two (2) longitudinal side surfaces 156 and two (2) transverse side surfaces 158. In this embodiment, the length, width and thickness of the insulating foam slab 124 generally correspond to the internal dimensions of the mold cavity (not shown) of the mold (not shown).

The insulating foam slab 124 is joined to the hardboard sheet 22 by a glue layer disposed between the inner surface 152 and the inwardly-facing surface 32. In this embodiment, the glue layer comprises hot melt adhesive.

As a result of the shorter length and shorter width of the insulating foam slab 124 relative to the hardboard sheet 22, the panel 120 comprises two (2) longitudinal recesses 162 and one (1) transverse recess 164. Each longitudinal recess 162 is adjacent the inwardly-facing surface 32 of the hardboard sheet 22 and a longitudinal side surface 156 of the insulating foam slab 124, and is sized to accommodate at least a portion of a vertically-oriented wall frame member, such as for example a lumber wall stud. The transverse recess 164 is adjacent the inwardly-facing surface 32 of the hardboard sheet 22 and a transverse side surface 158 of the insulating foam slab 24, and is sized to accommodate at least a portion of a horizontally-oriented wall frame member, such as for example a lumber header or baseplate. In this embodiment, and as may be seen, an opposite transverse side 158 of the insulating foam slab 124 is generally flush with a transverse side surface of the hardboard sheet 22.

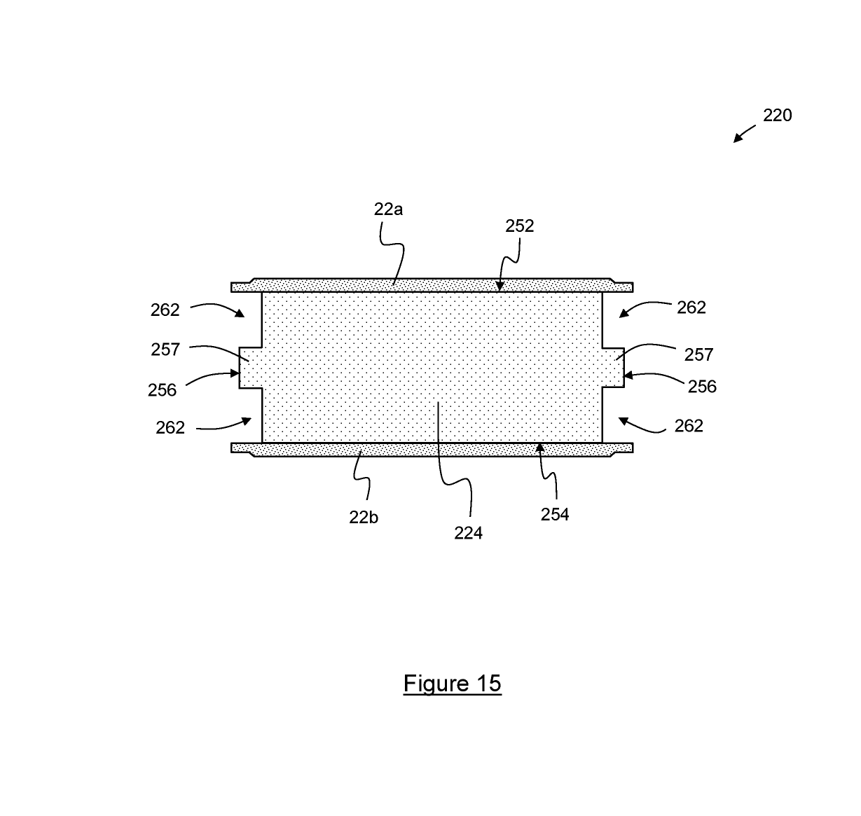

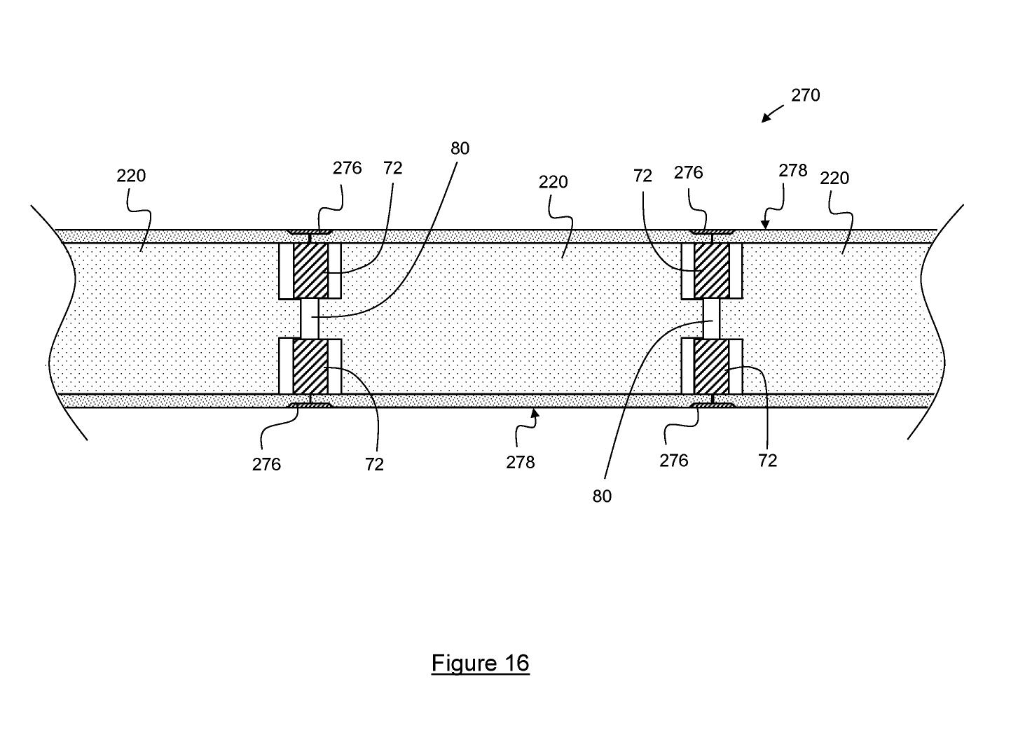

Still other configurations are possible. For example, FIG. 15 is a sectional view showing another embodiment of a dividing wall panel, and which is generally indicated by reference numeral 220. Panel 220 comprises a first fire-resistant hardboard sheet 22a and a second fire-resistant hardboard sheet 22b that are joined to an insulating foam slab 224. The insulating foam slab 224 is formed from a molded, continuous foam body that has been compressed either during or after molding, or both, to improve its sound insulation properties.

The first hardboard sheet 22a and the second hardboard sheet 22b are each identical to the hardboard sheet 22 of panel 20, which has been described above and with reference to FIGS. 1 to 9.

The insulating foam slab 224 has an elongate shape, and is fabricated of molded expanded polystyrene (EPS) foam in the same manner as described above for insulating foam slab 24.

The insulating foam slab 224 is sized such that its length is less than the length of each of the hardboard sheets 22a and 22b, and such that its width is less than the width of each of the hardboard sheets 22a and 22b. The insulating foam slab 24 has a first surface 252, a second surface 254, two (2) longitudinal side surfaces 256 and two (2) transverse side surfaces (not shown). In this embodiment, the length, width and thickness of the insulating foam slab 224 generally correspond to the internal dimensions of the mold cavity (not shown) of the mold (not shown).

In this embodiment, the insulating foam slab 224 has two (2) longitudinal recesses 262 formed within each longitudinal side surface 256 by hot wire cutting, and so as to define a longitudinal rib 257 that extends the length of the insulating foam slab 224. The insulating foam slab 224 also has two (2) transverse recesses (not shown) formed within each transverse side surface by hot wire cutting, and so as to define a transverse rib (not shown) that extends the width of the insulating foam slab 224. Each longitudinal recess 262 is sized to accommodate at least a portion of a vertically-oriented wall frame member, such as for example a lumber wall stud. Each transverse recess is sized to accommodate at least a portion of a horizontally-oriented wall frame member, such as a lumber header or baseplate.

The insulating foam slab 224 is joined to the first hardboard sheet 22a by a glue layer disposed between the first surface 252 and the inwardly-facing surface 32. The insulating foam slab 224 is joined to the second hardboard sheet 22b by a glue layer disposed between the first surface 254 and the inwardly-facing surface 32. In this embodiment, each of the glue layers comprises hot melt adhesive.

FIG. 16 shows a portion of a dividing wall incorporating the panel 220, and which is generally indicated by reference numeral 270. Dividing wall 270 is situated between adjacent, separate units of a multiple unit building structure (not shown), such as for example between adjacent dwelling units of an apartment building. The dividing wall 270 comprises a plurality of vertically-oriented wall frame members 72 arranged along two (2) rows, and in this embodiment the wall frame members 72 are lumber wall studs. The dividing wall 270 further comprises a plurality of panels 220 fastened to the wall frame members 72.

Each panel 220 is fastened to at least one wall frame member 72 using fasteners (not shown), and in this embodiment the fasteners are screws. Each fastener extends from the recessed surface 42 of the hardboard sheet 22a or 22b into the wall frame member 72. The panels 220 are fastened to the wall frame members 72 such that the hardboard sheets 22a or 22b of two (2) adjacent panels 20 abut along their longitudinal edges. As will be understood, when fastened in this manner, the longitudinal grooves 34 of two (2) abutting, adjacent panels 220 combine to form two (2) vertically-oriented longitudinal troughs. Each longitudinal trough has a quantity 276 of filler material disposed therein. In this embodiment, the filler material is joint compound. As will be understood, the quantity 276 of filler material conceals the joint formed between the abutting hardboard sheets 22a and 22b. Each quantity 276 of filler material is shaped so as to have a surface that is generally flush with the outwardly-facing surfaces 28 of the hardboard sheets 22a or 22b. As a result, and advantageously, each outer surface 278 of the dividing wall 270 is generally continuous and generally planar.

Although not shown, the dividing wall 270 also comprises a plurality of horizontally-oriented wall frame members (not shown) arranged along the top and bottom of each row of vertically-oriented wall frame members 72, and joining the vertically-oriented wall frame members 72 in the manner known in the art of wall framing. In this embodiment, the horizontally-oriented wall frame members are lumber headers and lumber baseplates, and each panel 220 is fastened to at least one lumber header and at least one lumber baseplate using fasteners, with each of the at least one lumber header and the at least one lumber baseplate being accommodated by a respective transverse recess of the panel 220.

When the panels 220 are fastened to the wall frame members, opposing hardboard sheets 22a and 22b are separated from each other by the thickness of the insulating foam slab 224, and by the longitudinal ribs 257 of the insulating foam slab 224 and an air gap 80 adjacent the wall frame members 72 and the longitudinal ribs 257. As a result, in addition to the improved sound insulation properties of the insulating foam slab 224 of each panel 220, each air gap 80 effectively provides a sound insulation barrier within the dividing wall 270.

Although in the embodiment described above, the longitudinal recesses and the transverse recesses of the insulating foam slab 224 are formed by hot wire cutting, in other embodiments, the longitudinal recesses and the transverse recesses may alternatively be formed by machining, such as for example by machining with a router. In still other embodiments, the longitudinal recesses and the transverse recesses of the insulating foam slab 224 may alternatively be formed during molding.

Although in embodiments described above, the hardboard sheet is fabricated of magnesium oxide, in other embodiments, the hardboard sheet may alternatively comprise a fiber cement board.

Although in embodiments described above, the insulating foam slab is fabricated by molding such that the length, width and thickness of the insulating foam slab generally correspond to the internal dimensions of the mold cavity of the mold, in other embodiments, the insulating foam slab may alternatively be cut from another insulating foam slab of larger size.

Although in embodiments described above, the continuous foam body is compressed “during” molding, whereby the molding machine applies external pressure to the mold which, in turn, causes the continuous foam body within the mold to be compressed, in other embodiments, the continuous foam body may alternatively be compressed “after” molding, whereby the continuous foam body is removed from the mold, and external pressure is alternatively applied by a different machine so as to cause the continuous foam body to be compressed. In one such embodiment, the continuous foam body may be cut from another continuous foam body of larger size prior to after application of external pressure by the different machine. In another embodiment, the continuous foam body may alternatively be compressed both “during” and “after” molding, whereby the molding machine applies external pressure to the mold which, in turn, causes the continuous foam body within the mold to be at least partially compressed, after which the at least partially compressed continuous foam body is removed from the mold, and external pressure is also applied by a different machine so as to cause the at least partially compressed continuous foam body to be further compressed.

Although in embodiments described above, the dividing wall panel is described as being for use in a dividing wall situated between adjacent, separate units of a multiple unit building, it will be understood that the panel may alternatively be used in other walls, as desired. For example, the dividing wall panel may alternatively be used in a wall of a mechanical room, in a wall of a bathroom or washroom, and the like.

Although embodiments have been described above with reference to the accompanying drawings, those of skill in the art will appreciate that variations and modifications may be made without departing from the scope thereof as defined by the appended claims.

What is claimed is:

1. A dividing wall panel comprising:
at least one elongate, fire-resistant hardboard sheet; and
an elongate insulating foam slab joined to the at least one hardboard sheet, the insulating foam slab being formed from a molded, continuous foam body compressed either during molding or after molding, or both, to improve its sound insulation properties.

2. The dividing wall panel of claim 1, wherein each hardboard sheet has an outwardly-facing surface, each hardboard sheet further comprising a longitudinal groove extending along each longitudinal edge of said outwardly-facing surface.

3. The dividing wall panel of claim 1, further comprising at least one longitudinal recess, each longitudinal recess being adjacent an inwardly-facing surface of each hardboard sheet.

4. The dividing wall panel of claim 3, wherein each longitudinal recess is sized to accommodate at least a portion of a vertically-oriented wall frame member.

5. The dividing wall panel of claim 4, wherein said vertically-oriented wall frame member is a wall stud.

6. The dividing wall panel of claim 1, further comprising at least one transverse recess, each transverse recess being adjacent an inwardly-facing surface of each hardboard sheet.

7. The dividing wall panel of claim 6, wherein each transverse recess is sized to accommodate at least a portion of a horizontally-oriented wall frame member.

8. The dividing wall panel of claim 7, wherein said wall frame member is a header or a baseplate.

9. The dividing wall panel of claim 1, wherein the insulating foam slab is fabricated of molded expanded polystyrene foam.

10. The dividing wall panel of claim 1, wherein each hardboard sheet is fabricated of magnesium oxide or comprises a fiber cement board.

11. The dividing wall panel of claim 1, wherein the insulating foam slab is joined to each hardboard sheet by a glue layer.

12. The dividing wall panel of claim 1, wherein the continuous foam body is subjected to at least one compression cycle.

13. A dividing wall incorporating the dividing wall panel of claim 1.

14. A method of fabricating a dividing wall, comprising:
fastening at least one dividing wall panel of claim 1 to each of a first row of wall frame members and a second row of wall frame members, the first row of wall frame members being spaced from the second row of wall frame members such that opposing dividing wall panels fastened to said wall frame members are separated by an air gap.

15. A method of fabricating a dividing wall panel, comprising:
joining at least one fire-resistant hardboard sheet to an insulating foam slab, the insulating foam slab having been formed by compressing a continuous foam body to form the insulating foam slab having improved sound insulation properties.

16. The method of claim 15, further comprising:
at least partially filling a mold with particles; and
applying heat to the particles within the mold to form the continuous foam body.

17. The method of claim 15, further comprising forming the insulating foam slab by one or more of:
applying external pressure to compress the continuous foam body within a mold used for molding said continuous foam body; and
removing the continuous foam body from a mold used for molding said continuous foam body, and applying external pressure to compress the continuous foam body.

18. The method of claim 15, wherein said compressing comprises permanently increasing the density of the continuous foam body.

19. The method of claim 15, wherein said joining comprises disposing a glue layer between each hardboard sheet and the insulating foam slab.

20. The method of claim 15, further comprising:
forming a longitudinal groove extending along a longitudinal edge of an outwardly-facing surface of each hardboard sheet.

21. The method of claim 15, further comprising:
forming at least one longitudinal recess along a longitudinal side surface of said insulating foam slab by at least one of machining, hot wire cutting and molding.

22. The method of claim 15, wherein said compressing comprises:
subjecting said continuous foam body to at least one compression cycle.

23. The method of claim 15, further comprising:
cutting said insulating foam slab from another insulating foam slab of larger size.

24. The method of claim 15, further comprising:
cutting said continuous foam body from another continuous foam body of larger size either prior to, during or after said compressing.
